(19) United States
(12) Patent Application Publication
(10) Pub. No.: US 2020/0162938 A1
(43) Pub. Date: May 21, 2020

(54) METHODS PROVIDING CONTROL AND DATA FRAMES USING DIFFERENT BEAM WIDTHS AND/OR FREQUENCIES AND RELATED WIRELESS COMMUNICATION NODES

(71) Applicant: TELEFONAKTIEBOLAGET LM ERICSSON (PUBL), Stockholm (SE)

(72) Inventors: Junaid Ansari, FÜRTH (DE); Gen Li, BEIJING (CN)

(21) Appl. No.: 16/614,866

(22) PCT Filed: May 19, 2017
(86) PCT No.: PCT/CN2017/085164

§ 371 Date: Nov. 19, 2019

(51) Int. Cl. H04W 16/28; H04W 76/11; H04W 72/04; H04L 5/00

(52) U.S. Cl. CPC H04W 16/28; H04W 76/11; H04W 72/046; H04L 5/0055; H04W 72/0453; H04W 72/042; H04W 72/0446

(57) ABSTRACT

A method of operating a first wireless communication node may include transmitting a control frame using a wide beam width transmission. The control frame may include identification information for the first wireless communication node and identification information for a second wireless communication node. In addition, a data frame including data for the second wireless communication node may be transmitted using a narrow beam width transmission, and the data frame may correspond to the control frame.

### TECHNICAL FIELD

The present disclosure generally relates to communications, and more particularly, to wireless communications and related wireless communication nodes.

### BACKGROUND

Mobile broadband may continue to drive demands for high overall traffic capacity and high achievable end-user data rates. Several use-cases and deployment scenarios may require data rates of up to 10 Gbps. These demands for very high system capacity and very high end-user data rates may be met by networks with distances between access nodes ranging from a few meters in indoor deployments to roughly 50 m in outdoor deployments (i.e., with an infrastructure density considerably higher than most dense networks of today). The wide transmission bandwidths used/needed to provide data rates of up to 10 Gbps and above may be obtained from spectrum allocations in the centimeter and millimeter-wave bands. High-gain beamforming, typically realized with array antennas, can be used to mitigate increased pathloss that may occur at higher frequencies, and to provide benefit from spatial reuse and multi-user schemes. Such networks are referred to as 5G New Radio (NR) in the following disclosure.

Besides using traditional licensed spectrum bands, NR is expected to operate in unlicensed bands and license shared bands, especially for enterprise deployment scenarios. Thus, coexistence support may be needed to enable efficient spectrum sharing among different operators and/or other systems. Listen-before-talk (LBT) may provide a flexible mechanism to achieve efficient spectrum sharing. LBT is a distributed mechanism so that there may be no need to exchange information between different coexisting systems. While LBT has been effective to provide spectral coexistence for wide beam width transmissions, numerous studies (as discussed for example, with respect to FIG. 3) have shown that LBT may be un reliable for highly directional transmissions.

Listen before talk may be used for example in Wi-Fi systems as shown in FIG. 1A. In typical deployments of WLAN, carrier sense multiple access with collision avoidance (CSMA/CA) may be used for medium access. This means that the channel is sensed to perform a clear channel assessment (CCA), and a transmission is initiated only if the channel is declared as Idle. In case the channel is declared as busy, the transmission is essentially deferred until the channel is deemed to be Idle. When the range of several access points APs using the same frequency overlap, this means that all transmissions related to one AP might be deferred in case a transmission on the same frequency to or from another AP which is within range can be detected. Effectively, this means that if several APs are within range, they may have to share the channel in time, and the throughput for the individual APs may be severely degraded compared to their isolated deployments. A general illustration of a listen before talk (LBT) mechanism is shown in FIG. 1A.

After a Wi-Fi station A transmits a data frame to a station B, station B shall transmit the ACK frame back to station A with a delay of 16 μs as shown in FIG. 1A. Such an ACK frame is transmitted by station B without performing the LBT operation. To prevent another station interfering with such an ACK frame transmission, a station shall defer for a duration of 34 μs (referred to as DIFS) after the channel is observed to be occupied before a subsequent attempt to assess again, whether or not the channel is occupied.

Therefore, a station that wishes to transmit first performs a CCA by sensing the medium for a fixed duration DIFS. If the medium is found to be idle, the station assumes that it may take ownership of the medium and begin a frame exchange sequence. If the medium is busy, the station waits for the medium to go idle, defers for DIFS, and waits for a further random back off period.

To further prevent a station from occupying the channel continuously and thereby prevent other stations from accessing the channel, a station wishing to transmit may be required after a transmission is completed to perform a random back off.

The PIFS is used to gain priority access to the medium, and is shorter in duration than the DIFS duration as shown in FIG. 1A. Among other cases, it can be used by stations STAs operating under PCF, to transmit Beacon Frames with priority. At the nominal beginning of each Contention-Free Period (CFP), the PC shall sense the medium. When the medium is determined to be idle for one PIFS period (generally 25 μs), the PC shall transmit a Beacon frame containing the CF Parameter Set element and a delivery traffic indication message element.

The widely used Wi-Fi systems based on IEEE 802.11g/n/ac standards operate at relatively low frequencies (e.g., 2.4 and 5 GHz frequencies), and listen and talk operations (i.e., sensing, reception and transmission) are predominantly omni-directional. An objective of listen before talk is to reduce/avoid interference between simultaneous data transmission. Practical application results show that this generally works well in Wi-Fi.

When using Listen before talk for LAA systems, the eNB may transmit a transmission including PDSCH on a channel on which LAA Scell(s) transmission(s) are performed, after first sensing the channel to be idle during the slot durations of a defer duration T_{d} and after the counter reaches zero in operation 4 (discussed below). The counter N is adjusted by sensing the channel for additional slot duration(s) according to the operations below:
1. Set N=Nᵢₙᵢₜ, where Nᵢₙᵢₜ is a random number uniformly distributed between 0 and CWₚ, and go to operation 4;
2. If N>0 and the eNB chooses to decrement the counter, set N=N−1;
3. Sense the channel for an additional slot duration, and if the additional slot duration is idle, go to operation 4; else, go to operation 5;
4. If N=0, stop; else, go to step 2.
5. Sense the channel during the slot durations of an additional defer duration T_{d′};
6. If the channel is sensed to be idle during the slot durations of the additional defer duration T_{d}, go to step 2; else, go to step 5;

If an eNB has not finished a transmission including PDSCH on a channel on which LAA Scell(s) transmission(s) are performed after operation 4 in the procedure above, the eNB may transmit a transmission including PDSCH on the channel, after sensing the channel to be idle at least in the slot durations of an additional defer duration T_{d}.

The defer duration T_{d} consists of duration 16 μs≤T_{f}≤16 μs+Tₛ, immediately followed by mₚ consecutive slot durations where each slot duration is 9 μs≤Tₛₗ≤9 μs+Tₛ, and T_{f} includes an idle slot duration Tₛₗ at start of T_{f}.

A slot duration Tₛₗ is considered to be idle if the eNB senses the channel during the slot duration, and the power detected by the eNB for at least 4 μs within the slot duration is less than energy detection threshold X_{Thresh}. Otherwise, the slot duration Tₛₗ is considered to be busy.

CW_{min,p}≤CWₚ≤CW_{max,p} is the contention window. CW_{min,p} and CW_{max,p} are chosen before operation 1 of the procedure above. mₚ, CW_{min,p} and CW_{max,p} are based on channel access priority class associated with the eNB transmission, as shown in Table 1.

If the eNB transmits discovery signal transmission(s) not including PDSCH when N>0 in the procedure above, the eNB shall not decrement N during the slot duration(s) overlapping with discovery signal transmission.

The eNB shall not continuously transmit on a channel on which the LAA Scell(s) transmission(s) are performed, for a period exceeding T_{mcot,p} as given in the table of FIG. 1B, which illustrates channel access priority class.

For p=3 and p=4, if the absence of any other technology sharing the carrier can be guaranteed on a long term basis (e.g. by level of regulation), T_{mcot,p}=10 ms, otherwise, T_{mcot,p}=8 ms.

Performance of listen before talk mechanisms in systems with directional communications, however, may be insufficient, for example, due to issues relating to hidden and exposed terminals.

### SUMMARY

According to some embodiments of inventive concepts, a method of operating a first wireless communication node may include transmitting a control frame using a wide beam width transmission. The control frame may include identification information for the first wireless communication node and identification information for a second wireless communication node. The method may also include transmitting a data frame including data for the second wireless communication node using a narrow beam width transmission, with the data frame corresponding to the control frame.

According to some other embodiments of inventive concepts, a first wireless communication node may be adapted to transmit a control frame using a wide beam width transmission. The control frame may include identification information for the first wireless communication node and identification information for a second wireless communication node. The wireless communication node may also be adapted to transmit a data frame including data for the second wireless communication node using a narrow beam width transmission, with the data frame corresponding to the control frame.

According to still other embodiments of inventive concepts, a first wireless communication node may include a transceiver configured to provide wireless communications, and a processor coupled with the transceiver. The processor may be configured to provide wireless communication through the transceiver. The processor may also be configured to transmit a control frame using a wide beam width transmission. The control frame may include identification information for the first wireless communication node and identification information for a second wireless communication node. In addition, the processor may be configured to transmit a data frame including data for the second wireless communication node using a narrow beam width transmission, wherein the data frame corresponds to the control frame.

According to further embodiments of inventive concepts, a method may be provided to operate a first wireless communication node in communication with a second wireless communication node. A control frame may be received from the second wireless communication node using at least one of a first set of frequencies, and the control frame may include identification information for the second wireless communication node and identification information for the first wireless communication node. A data frame may be received from the second wireless communication node using at least one of a second set of frequencies. The data frame may include data for the first wireless communication node, and the data frame may correspond to the control frame. Moreover, frequencies of the first set of frequencies may be lower than frequencies of the second set of frequencies.

According to still further embodiments of inventive concepts, a first wireless communication node may be configured to provide communication with a second wireless communication node. A control frame may be received from the second wireless communication node using at least one of a first set of frequencies, and the control frame may include identification information for the second wireless communication node and identification information for the first wireless communication node. A data frame may be received from the second wireless communication node using at least one of a second set of frequencies. The data frame may include data for the first wireless communication node, and the data frame may correspond to the control frame. Moreover, frequencies of the first set of frequencies may be lower than frequencies of the second set of frequencies.

According to yet further embodiments of inventive concepts, a first wireless communication node may include a transceiver configured to provide wireless communications, and a processor coupled with the transceiver. The processor may be configured to provide wireless communication through the transceiver. The processor may be further configured to receive a control frame from a second wireless communication node using at least one of a first set of frequencies. The control frame may include identification information for the second wireless communication node and identification information for the first wireless communication node. The processor may also be configured to receive a data frame from the second wireless communication node using at least one of a second set of frequencies. The data frame may include data for the first wireless communication node, and the data frame may correspond to the control frame. Moreover, frequencies of the first set of frequencies may be lower than frequencies of the second set of frequencies.

By communicating control and data frames for listen after talk communications using different beam widths and/or different frequencies, an efficiency of operation may be improved and/or interference may be reduced.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1A is a diagram illustrating listen before talk (LBT) operations for Wi-Fi communications;

FIG. 1B is a table illustrating channel access priority class;

FIG. 2 is a signaling diagram illustrating an example of listen after talk LAT operations;

FIGS. 3A and 3B are graphs illustrating mean object and cell edge user experienced rate vs served system throughput;

FIG. 4 is a diagram illustrating transmission of data using narrow beam directional transmission while the control information is transmitted using an omni-directional antenna radiation pattern according to some embodiments of inventive concepts;

FIG. 5 is a diagram illustrating transmission of data using narrow beam directional transmission while the control information is transmitted using a wide beam width according to some embodiments of inventive concepts;

FIG. 6 is a diagram illustrating use of spatial multiplexing for data transmission while the control and coordination is handled using a wide beam width according to some embodiments of inventive concepts;

FIG. 7 is a diagram illustrating listen after talk using narrow beam directional communication for data exchange and using a wider beam width for control according to some embodiments of inventive concepts;

FIG. 8 is a flow chart illustrating LAT transmitter operations using narrow and wide beam widths for control and data transmissions according to some embodiments of inventive concepts;

FIG. 9 illustrates a receiver side flowchart for LAT using narrow and wide beam widths for control and data transmissions, respectively, according to some embodiments of inventive concepts;

FIG. 10 is a table providing information relating to channel access priority classes;

FIG. 11 is a block diagram illustrating a wireless terminal according to some embodiments of inventive concepts;

FIG. 12 is a block diagram illustrating an access node according to some embodiments of inventive concepts;

FIGS. 13A and 13B are flow charts illustrating access node operations according to some embodiments of inventive concepts;

FIG. 14 is a block diagram illustrating access node memory modules according to some embodiments of inventive concepts;

FIG. 15 is a flow chart illustrating wireless terminal operations according to some embodiments of inventive concepts; and

FIG. 16 is a block diagram illustrating wireless terminal memory modules according to some embodiments of inventive concepts.

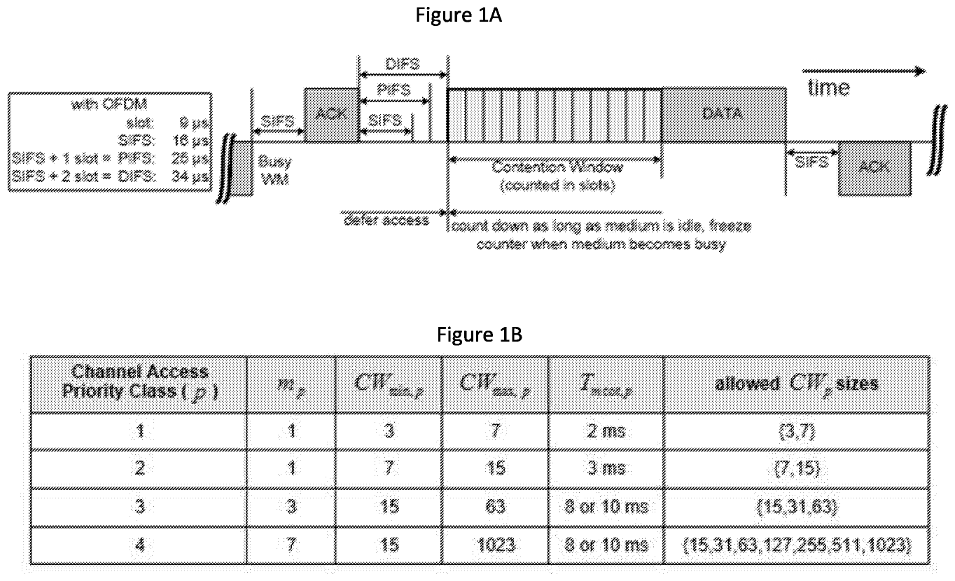

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

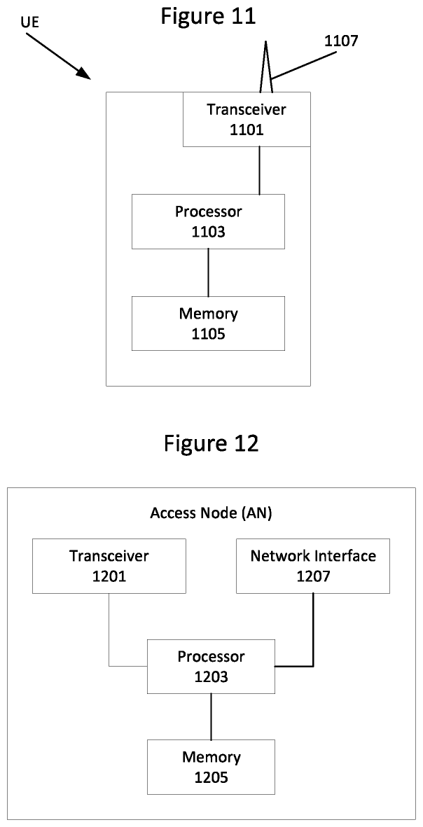

FIG. 11 is a block diagram illustrating elements of a wireless terminal UE (also referred to as a wireless device, a wireless communication device, a wireless communication terminal, user equipment, a user equipment node/terminal/device, etc.) configured to provide wireless communication according to embodiments of inventive concepts. As shown, wireless terminal UE may include an antenna 1107, and a transceiver circuit 1101 (also referred to as a transceiver) including a transmitter and a receiver configured to provide uplink and downlink radio communications with a base station(s) of a radio access network, and/or to provide device-to-device (D2D) communications (also referred to as sidelink communications) with another wireless terminal. Wireless terminal UE may also include a processor circuit 1103 (also referred to as a processor, e.g., a Central Processing Unit CPU, Graphics Processing Unit GPU, Digital Signal Processor DSP, Field Programmable Gate Array FPGA, Application Specific Integrated Circuit ASIC, etc.) coupled to the transceiver circuit, and a memory circuit 1105 (also referred to as memory) coupled to the processor circuit. The memory circuit 1105 may include computer readable program code that when executed by the processor circuit 1103 causes the processor circuit to perform operations according to embodiments disclosed herein. According to other embodiments, processor circuit 1103 may be defined to include memory so that a separate memory circuit is not required. Wireless terminal UE may also include an interface (such as a user interface) coupled with processor 1103, and/or wireless terminal UE may be incorporated in a vehicle.

As discussed herein, operations of wireless terminal UE may be performed by processor 1103 and/or transceiver 1101. For example, processor 1103 may control transceiver 1101 to transmit communications through transceiver 1101 over a radio interface to a network access node (or to another UE) and/or to receive communications through transceiver 1101 from a network access node (or another UE) over a radio interface. Moreover, modules may be stored in memory 1105, and these modules may provide instructions so that when instructions of a module are executed by processor 1103, processor 1103 performs respective operations (e.g., operations discussed below with respect to Example Embodiments).

FIG. 12 is a block diagram illustrating elements of an access node AN (also referred to as a network node, base station, eNB, eNodeB, etc.) of a Radio Access Network (RAN) configured to provide wireless/cellular communication according to embodiments of inventive concepts. As shown, the access node may include a transceiver circuit 1201 (also referred to as a transceiver) including a transmitter and a receiver configured to provide uplink and downlink radio communications with wireless terminals. The access node may include a network interface circuit 1207 (also referred to as a network interface) configured to provide communications with other nodes (e.g., with other base stations) of the RAN. The access node may also include a processor circuit 1203 (also referred to as a processor, e.g., a Central Processing Unit CPU, Graphics Processing Unit GPU, Digital Signal Processor DSP, Field Programmable Gate Array FPGA, Application Specific Integrated Circuit ASIC, etc.) coupled to the transceiver circuit, and a memory circuit 1205 (also referred to as memory) coupled to the processor circuit. The memory circuit 1205 may include computer readable program code that when executed by the processor circuit 1203 causes the processor circuit to perform operations according to embodiments disclosed herein. According to other embodiments, processor circuit 1203 may be defined to include memory so that a separate memory circuit is not required.

As discussed herein, operations of the access node may be performed by processor 1203, network interface 1207, and/or transceiver 1201. For example, processor 1203 may control transceiver 1201 to transmit communications through transceiver 1201 over a radio interface to one or more UEs and/or to receive communications through transceiver 1201 from one or more UEs over a radio interface. Similarly, processor 1203 may control network interface 1207 to transmit communications through network interface 1207 to one or more other network nodes and/or to receive communications through network interface from one or more other network nodes. Moreover, modules may be stored in memory 1205, and these modules may provide instructions so that when instructions of a module are executed by processor 1203, processor 1203 performs respective operations (e.g., operations discussed below with respect to Example Embodiments).

Unlike communications using omni-directional transmit and receive antenna radiation patterns, directional communications may have different hidden and exposed terminal problems. Moreover, narrow beam width directional transmissions may be more prone to a deafness problem compared to wider beam width transmissions. The hidden terminal problem refers to a situation when the transmitter is unable to listen to the potential interferer resulting in packet collision (causing interference) at the receiver. The exposed terminal problem refers to a situation when the potential transmitter overhears an ongoing transmission and refrains from its own transmission although the ongoing transmission would not have interfered with its transmission at the receiver. The deafness problem refers to a situation when a receiver is unable to hear the (directional) transmission from a transmitter.

LAT operations are introduced to reduce the abovementioned hidden- and exposed-node problems in systems using directional transmission (e.g., using large) to provide directional communications. A reason that LBT has such problems with directional communications is the large difference between sensed power at the source node (SN) side and interference power at the destination node (DN) side in high gain beamforming cases. LBT relies on listening at transmitter side to determine if there will be interference at the receiver side and thus a large difference between strengths of a potentially interfering signal at the transmitter and receiver sides may result in significant problems. To reduce these issues, LAT considers involving the receiver to sense the channel directly. Another motivation for LAT is the possibility of a low interference environment (i.e., low number of collisions for naïve direct transmissions). For this reason, LAT adopts a different logic compared to LBT, described as follows. The default mode for the LAT transmitter is ‘to send’ and a clear channel assessment is not required to send data. The sending node SN transmits when data packets arrive and then resolves collisions detected by destination node DN using coordination signaling.

In order to more clearly understand LAT, the terms Idle time, Notify-to-Send, and Notify-Not-To-Send are introduced. Idle time is assumed after continuous data transmission. This is reasonable for shared spectrum (e.g., unlicensed band) since there are typically channel occupation limitation rules (e.g., the SN must stop transmitting and enter idle state after the contiguous transmission time exceeds a given threshold). A Notify-To-Send (NTS) message can be transmitted by SN or DN, and may include the link information which will transmit data and expected occupation time duration. Notify-Not-To-Send (NNTS) message may be transmitted from DN, telling its SN not to transmit data in indicated duration.

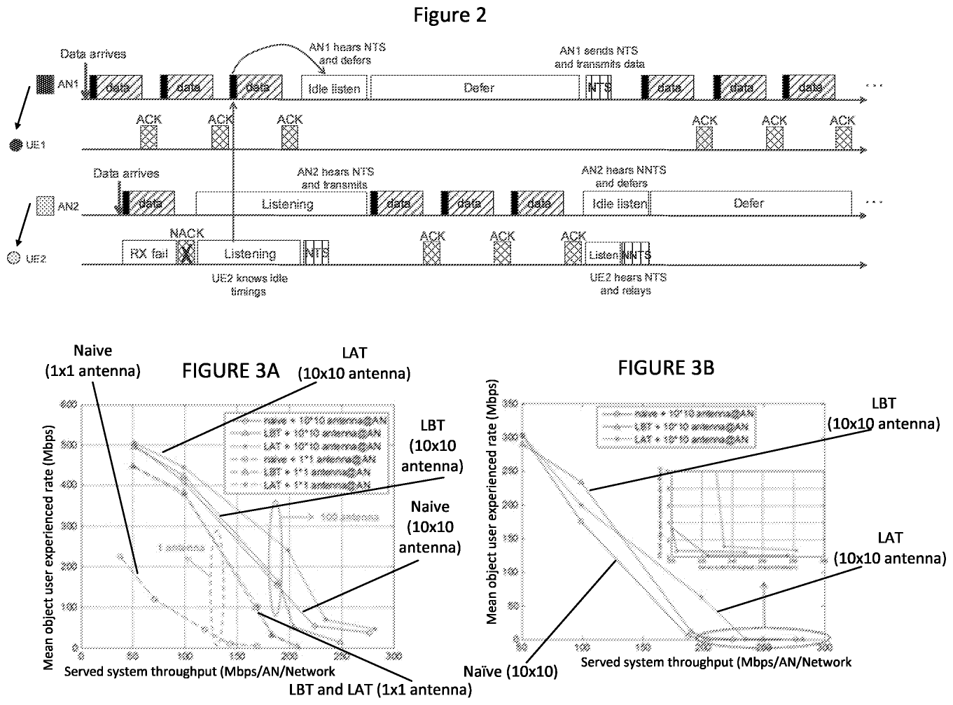

FIG. 2 is a signaling diagram illustrating an example of a listen after talk procedure, where the link AN1->UE1 interferes with the link AN2->UE2. First, the listening function at the DN side (UE2) is triggered when it detects interference (from the AN1->UE1 link) and fails to receive the data from the SN (AN2). Then, the DN (UE2) of interfered link will coordinate the data transmission with SN (AN1) of the interfering link(s). Finally, the coordination will be performed in an idle time of the interfering link. In the non-limiting example in FIG. 2, the AN1->UE1 link interferes with the AN2->UE2 link. When UE2 fails to decode the data, it starts to look for the idle period of the interfering link and sends NTS (Notify To Send) message towards the AN2 direction. Since UE2 is interfered by AN1, AN1 can receive the message as well and then defer the transmission as NTS indicates. Besides, NTS may also indicate when AN2 will stop transmission and listen, i.e., idle period of AN2->UE2. Then, AN1 transmits NTS that can be received by UE2. Finally, NNTS (Notify Not To Send) is relayed by UE2 to let its transmitter AN2 know which resource is occupied by the interfering link and refrain from transmitting. By this scheme, the transmission of this interference pair (i.e. AN1-UE1 and AN2-UE2) is coordinated in a distributed way in order to carry out transmissions efficiently by taking turns.

In order to compare different coexistence mechanisms, simulations have been conducted to study both mean object user experience rate and 5% cell edge user rate under different traffic settings. FIGS. 3A and 3B are graphs illustrating mean object and cell edge user experienced rate vs served system throughput. From dashed curves in FIGS. 3A and 3B, it can be observed that LBT may work better than naïve schemes (i.e., direct transmission without any coordination) and may provide performance similar to that of LAT in a 1 antenna case. This means that LBT may be preferred in current systems. However, in a 100 antenna array case as shown in solid lines of FIGS. 3A and 3B, LBT may provide performance that is similar to that of a naive scheme in a low traffic case and performance that is worse than a naïve scheme in a high traffic case. On the other hand, LAT may provide better performance than LBT in terms of mean and 5% cell edge experienced rate.

As discussed above with respect to FIGS. 3A and 3B, listen after talk may provide better performance than listen before talk in beamforming cases with massive MIMO (i.e., large antenna systems) and/or for directional transmissions. However, NR and/or other future wireless systems with high gain beamforming may suffer from problems of blockage and deafness if further mechanisms for beam coordination and steering are not provided. Mobility of devices, deployment conditions, and radio propagation environmental factors may cause occlusion and/or distortion for directional communication systems. Therefore, further mechanisms for resilience and/or reliable operation between the transmitter and receiver may be useful as described in further detail below.

To further address issues such as blockage and/or deafness, some embodiments of inventive concepts may provide listen-after-talk (LAT) operation whereby control and data transmission are split across low and high frequency spectra, respectively. The control and coordination information may be sent out using wider beam width transmissions (for example, using at least one of a set of frequencies in a relatively low frequency band) to reduce issues relating to deafness and blockage, and to provide reliable coordination/control. Data transmissions may be carried out using highly directional transmissions (e.g., using centimeter and millimeter wavelengths having potentially large bandwidth) so that high data rates can be achieved and spatial reuse can be exploited. According to some embodiments of inventive concepts, advantages of low frequency bands (e.g., sub 6 GHz bands) may be exploited by using them for control and coordination purposes, and advantages of high frequency bands (e.g., cm and mm-Wave frequency bands) may be exploited by using them for highly directional transmissions for high data rates and/or spatial multiplexing. Different embodiments are described for more flexibility and reconfiguration, and support both standalone and license assisted operations.

According to some embodiments of inventive concepts, LAT operations may be used for directional transmissions to reduce issues relating to use of LBT based medium access as discussed above with respect to FIGS. 3A and 3B. System performance and/or efficiency may be improved by splitting the control and data in low and high frequency spectra respectively combines the advantages and offsets the disadvantages.)

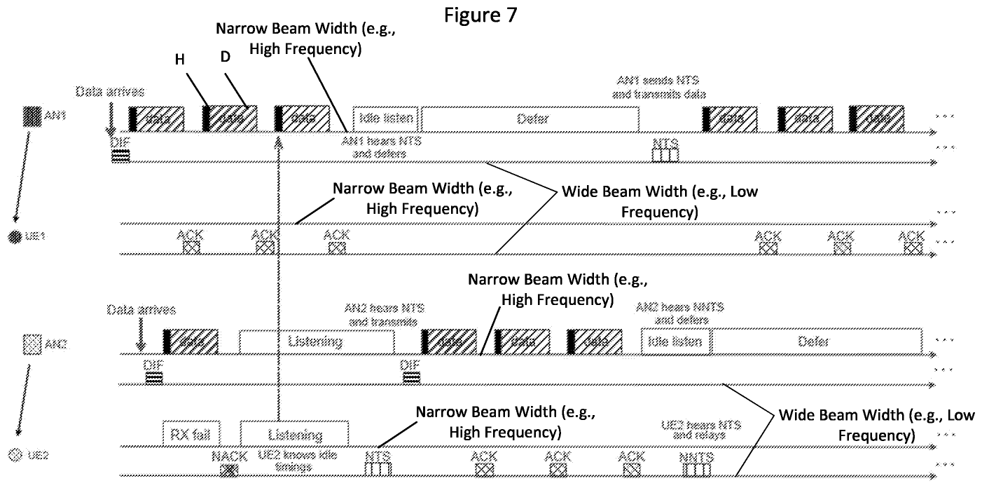

Low-frequency bands with wider beam widths may be used for reliable coordination and control as such low frequency bands do not suffer from strong blockage and deafness as may be the case for highly directional communication. Low frequencies may not suffer from strong pathloss and may provide reasonable communication range with large beam widths (in extreme cases even omni directional radiation patterns). Such low frequency bands may allow re-coordination of beam steering and/or re-establishing of data communication to be quickly carried out when the directional communication using high frequencies may suffer from occlusion or interference (e.g., as discussed below with respect to FIG. 7). This may allow faster signaling between transmitter, receiver, and potential interferer, which may allow faster resolution and reconfiguration. The low frequency bands can also provide a fall back for data communication.

High frequency bands may be used for directional data transmission as directivity gains may allow reasonable communication range. Large bandwidths may be available in high frequency bands (e.g., in the centimeter and millimeter wavelengths), and such large bandwidths may allow high data rates as targeted by 5G use-cases. Directional transmissions may also allow spatial reuse thereby providing high spectral efficiency.

Besides licensed frequencies, some embodiments of inventive concepts may allow standalone (only unlicensed frequency bands) as well as license-assisted modes of operation in shared frequency spectrum bands.

Another advantage of some embodiments may be to allow the radio interface for directional communication to be in low power mode, power down mode, or sleep mode to reduce energy consumption. Based on the received control information, the radio interface for the directional communication can be switched to the active mode.

Although terminology from 3GPP NR has been used in this disclosure by way of example, this should not be seen as limiting the scope of inventive concepts to only the aforementioned systems. Other wireless systems such as Wi-Fi may also benefit from exploiting inventive concepts within this disclosure.

While there may be strong reasons to use cm-Wave and/or mm-Wave frequencies for directional communication, some embodiments of inventive concepts may also be valid for other lower frequencies, where directional transmissions may be used. Inventive concepts may apply to unlicensed spectrum, license shared spectrum, and/or licensed spectrum.

Terminologies such as base station/eNodeB and UE should be considered non-limiting and do not imply a certain hierarchical relation between the two. In general, an “eNodeB” could be considered as device 1 and a “UE” could be considered as device 2, and these two devices may communicate with each other over some radio channel(s).

Embodiments of inventive concepts are disclosed/illustrated herein. These embodiments are not mutually exclusive. Components from one embodiment may be tacitly assumed to be present in another embodiment and it will be obvious to a person skilled in the art how those components may be used in the other exemplary embodiments.

While low and high frequency bands are discussed herein, inventive concepts are not only tied to support one low frequency band and one high frequency band. Inventive concepts may allow support for multiple low and high frequency bands that can be combined through carrier aggregation or channel bonding schemes. Due to strong pathloss in high frequencies (e.g., cm and mm wavelength frequencies), directional transmission may be preferred in high frequencies so that directivity gains can be exploited to achieve reasonable communication range. As pathloss may not be as pronounced in lower frequencies, wider beam widths (even omni directional radiation patterns) can be used in low frequencies for robust control and coordination. Moreover, due to small wavelengths in high frequencies, it may be easier to fabricate multi-antenna element arrays for beamforming for directional transmission. However, embodiments of inventive concepts do not necessarily limit the use of low frequencies only for control frame transmissions or the use of high frequencies only for directional user data transmission.

Embodiments of inventive concepts do not necessarily restrict certain communications to low or high frequency spectra. There may be, however, reasons that low frequencies with wide antenna radiation patterns could be used for control and coordination, while high frequencies could be used for highly directional data transmission links with possible spatial multiplexing. In principle, there is a possibility to use wide beam width control information and achieve large range by using high transmit power levels. Similarly, directional data transmissions can also be carried out in low frequencies using MU-MIMO and spatial multiplexing techniques. The underlying rationale for the preference to use high and low frequency spectra is discussed below.

Due to high path loss, high frequencies (e.g., cm and mm wavelength) may suffer from high attenuation and may thus require high transmission power to achieve a desired communication range. In contrast, due to a small wavelength, it may be easier to design multi-antenna element arrays to achieve narrow beam width transmissions (e.g., in a small occupied area) and thereby exploit directivity gains to achieve reasonable transmission ranges. Directional communication may also allow spatial multiplexing (e.g., using MU-MIMO that may be part of future wireless systems such as 5G NR). Typically, there may be large bandwidth available in high frequency bands which allows high user data rates as may be required by 5G use-cases.

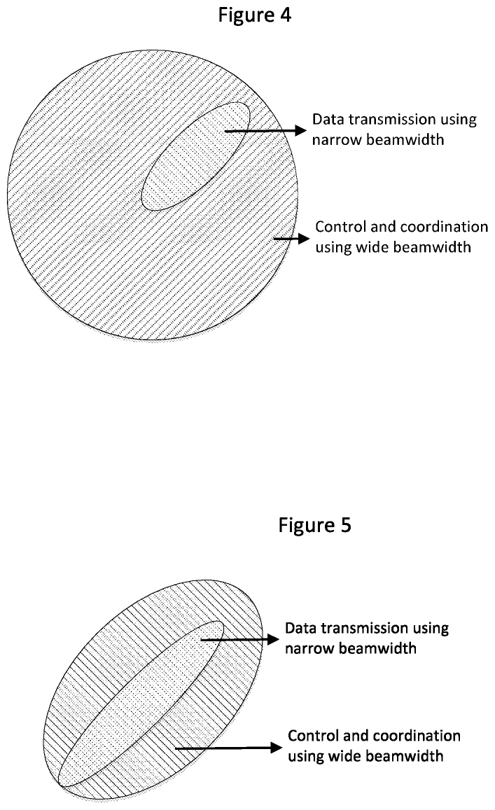

Since directional transmissions (especially in cm and mm wave frequencies) may be prone to blockage and deafness problems, low frequencies may be preferred to achieve reliable control and coordination. Owing to low pathloss, low range frequencies (e.g., sub 6 GHz) can leverage from wider beam widths to provide more robust control and coordination. While typically there may not be very large bandwidth available in lower frequencies, the available small bandwidths may suffice to provide the control and coordination frame transmission. FIGS. 4 and 5 illustrate data transmission carried out using narrow beam directional transmission while the control information is transmitted using wide beam width.

FIG. 4 is a diagram illustrating transmission of data using narrow beam directional transmission while the control information is transmitted using an omni-directional antenna radiation pattern.

FIG. 5 is a diagram illustrating transmission of data using narrow beam directional transmission while the control information is transmitted using a wide beam width.

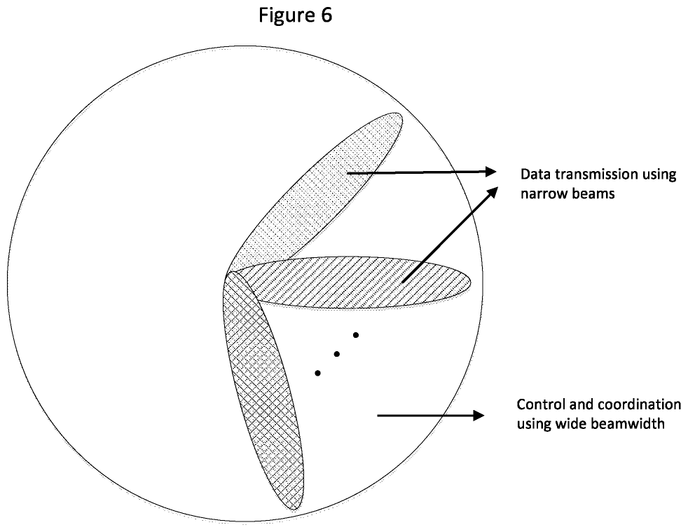

Narrow beam width directional transmissions may allow MU-MIMO and spatial multiplexing for data transmission as indicated in the illustration of FIG. 6. The control and coordination information for such spatial multiplexed transmission may be handled over a wide beam width transmission. As shown in FIG. 6, spatial multiplexing may be used for data transmission while the control and coordination is handled using a wide beam width.

Timing information and frame exchange scheme are discussed with respect to FIG. 7, where FIG. 7 is a signaling diagram illustrating a listen after talk scheme where the control information is transmitted over a wider beam width while the directional data transmission is carried out using narrow beam width transmissions. For the sake of simplicity, the example shown in FIG. 7 is similar to the LAT example of FIG. 2. In FIG. 2, however, the LAT operations were provided using only highly directional communications. In the examples of FIGS. 2 and 7, link AN2->UE2 is interfered by the link AN1->UE1. Advantages of LAT operations of FIG. 7 may include robustness against blockage and deafness, and efficient coordination for reliable data transmission.

In FIG. 7, data communication from AN1 to UE1 and AN2 to UE2 is considered. When data arrives at AN1, it issues a control frame (Data indication frame (DIF)) using the wide beam width transmission. This control information includes addressing information for UE1 and source information of AN1, which allows UE1 to be prepared to receive directional data (e.g., switching on the radio interface for directional communication, turning the receiver side antenna beam towards the reception from AN1, etc.). This control information in the Data Indication Frame DIF also allows other nodes in the communication range to know about an upcoming data transmission from AN1 to UE1, and the medium occupation duration. Thus, other nodes may be able to adjust their behavior accordingly (e.g., refrain from transmission for the indicated duration, not transmitting in the interfering direction, etc.). This scheme may provide an advantage over the other LAT schemes using only (highly) directional communication and may lead to substantially lower interference likelihood.

After the control frame transmission, AN1 transmits data frames (with each data frame including a header H and a data block D) to UE1 using highly directional transmission. The transmitted frames are acknowledged by UE1 using wide beam width transmission. When data arrives at AN2 to be transmitted to UE2, AN2 sends a DIF using the wide beam width transmission followed by the directional data frame transmission. In the example of FIG. 7, AN2->UE2 directional data transmission is interfered by the directional data transmission AN1->UE1. When UE2 fails to decode data or no data is received after receiving DIF, UE2 starts to look for the idle period of the interfering data transmission link and sends an NTS message. Since UE2 is interfered by AN1, AN1 can receive the NTS message as well and then defer further transmission as NTS indicates. Alternatively, the issued NACK frame could serve as an indicator to AN1 to defer appropriately to allow the transmission of AN2. NTS also indicates when AN2 will stop transmission and listen (i.e., the idle period of AN2->UE2). Having a more robust control mechanism (e.g., DIF and NACK) according to some embodiments may allow additional means for AN1 to be informed of the interfering AN2 transmission and arbitrate the medium accordingly.

After AN2 finishes transmission, AN1 transmits NTS using a wide beam width transmission followed by data transmission using highly directional transmission. NTS transmission by AN1 may serve the purpose for DIF here and hence no explicit DIF is transmitted. Since NTS transmission by AN1 is also received by UE2, it relays it to AN2 as NNTS. Consequently, AN2 may defer and refrain from transmitting. Using embodiments of FIG. 7, transmission of the interfering pairs (i.e., AN1-UE1 and AN2-UE2) may be coordinated in a distributed way and efficient transmissions may be achieved.

Compared to LAT operations of FIG. 2 using only directional transmission, operations of FIG. 7 may enable more robustness against deafness problems, hidden terminal problems, and/or asymmetric links. This may lead to substantially lower interference from other links and may allow more efficient data communication. In case interference or occlusion happens to directional communication, embodiments of FIG. 7 may allow robust and fast mechanisms for resolution. Moreover, the wireless interface for directional transmission can be switched on only when data communication is needed, thereby achieving power savings. Energy conservation especially for battery powered devices (e.g., wireless terminal devices) may be beneficial.

According to some embodiments, only licensed frequencies in the low and high frequency spectra may be supported.

As another embodiment, licensed frequencies may be used in the low frequency spectrum while shared frequencies (e.g., unlicensed frequencies, or license shared frequencies) are used in the high frequency spectrum (i.e., license assisted operation). As an example, LTE spectrum may be used for coordination and control while 60 GHz unlicensed spectrum is used for highly directional user data transmission.

As another embodiment, the low and high frequency spectra may be in the unlicensed frequencies (i.e., standalone operation). Here, the system would use any mandatory regulations (e.g., the use of the LBT principle, radio duty cycle constraints, transmit-power limits, etc.). An example of this could be use of 5 GHz spectrum for control and coordination while 60 GHz spectrum is used for highly directional data transmission. In this non-limiting example, inline to European regulations, LBT operation could be performed before transmission of the control frames in the 5 GHz unlicensed spectrum.

According to some embodiments, the low frequency spectrum may be in the shared frequencies while the high frequency spectrum is licensed.

Due to regulatory constraints and/or to support coexistence with other collocated systems, if LBT is necessary, LBT operation can be performed before issuing control frame transmissions or even data frame transmissions. Besides having a regulatory requirement, LBT could also be used to reduce/minimize collision probability and support coexistence.

As shown in FIG. 7, the disjoint nature of control and data frame transmission may also allow that instead of two separate radio interface chains or at least two sets of frequencies, the same frequency could be used with fast switching between highly directional mode for data exchange and wider beam width for control information exchange. The directivity gains and transmit power levels may need to be adjusted accordingly in this case.

As another embodiment, when the data size is very small, instead of using explicit directional communication, user data can be sent using the wider beam width transmission similar to control information.

As a further embodiment, the DIF could be used to schedule data transmission in both low frequency and high frequency bands. The data in low frequency bands could be transmitted along with DIF so that only one round of LBT is needed for DIF and data transmission. In addition, the data transmission in the low frequency band and the high frequency band could be time overlapping if two radio chains are available. Accordingly, there may be no need to have time orthogonal transmission as shown in FIG. 7.

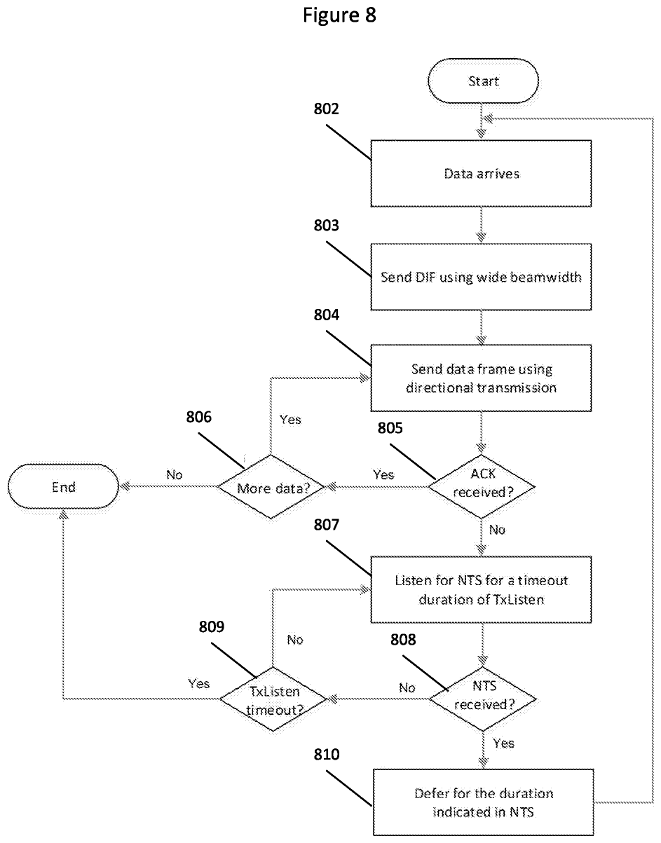

FIG. 8 is a flow chart illustrating LAT transmitter (e.g., access node AN1) operations using narrow and wide beam widths for control and data transmissions, respectively. As discussed above with respect to FIG. 7, the data transmission is carried out using directional communication. The receiver (e.g., wireless terminal UE1) may also use receiver side beamforming to exploit the directivity gains for data reception. The control frames may be transmitted using wide beam width transmission, and the receiving node (e.g., wireless terminal UE1) may use wide beam width radiation pattern at the receiver side to receive the control frames.

When data arrives at AN1 for transmission to UE1 at block 802, access node AN1 sends out a Data Indicator Frame (DIF) at block 803 using a wide beam width (e.g., this can be carried out in a low frequency spectrum band). If due to regulatory constraints in the unlicensed spectrum LBT needs to be performed before sending out the DIF, access node AN1 can also perform an LBT clear channel assessment before transmitting the DIF. The DIF may include information regarding the transmitter node AN1 and the receiver node UE1, and the expected medium occupancy time. This information may allow any interfering nodes and/or potentially interfered nodes to refrain from transmitting or carry out transmissions in non-interfering directions.

After the DIF frame has been transmitted, access node AN1 may use directional transmission to send the first data frame at block 804. This operation could involve first switching on the directional communication radio interface chain. The directional communication can be carried out using a high frequency spectrum (e.g., cm and/or mm wave frequency spectrum).

After transmitting a data frame using directional communication, access node AN1 waits for a corresponding acknowledgement from the receiver UE1. The acknowledgement is transmitted by UE1 using a wide beam width and/or the access node AN1 uses receiver side wide beam radiation pattern to receive the acknowledgement (ACK) frame. At block 805, access node AN1 checks if the ACK frame corresponding to the transmitted data frame has been received.

If the ACK frame has been received, the access node AN1 checks if there is more data to be transmitted at block 806. If more data needs to be transmitted, access node AN1 carries out further data transmissions using directional communication at block 804, and subsequently waits for respective ACKs. The transmitting access node AN1 checks afterwards if more data needs to be transmitted at block 806. If more data is not to be transmitted, the transmission procedure may be completed.

If an ACK frame is not received at block 805, access node AN1 may start a certain operator configurable timeout timer (TxListen). During the timeout period, access node AN1 listens for an NTS frame at block 807 (corresponding to the idle listen period of FIG. 7).

At block 808, access node AN1 checks if it has received an NTS frame during the TxListen timeout duration. If the NTS frame is received, the node goes to the deferral state for a duration indicated in the NTS frame at block 810. After the deferral time, access node AN1 may attempt to transmit the non-transmitted data.

If at block 808, no NTS frame is received, access node AN1 waits for the timeout timer TxListen to expire. If the TxListen timer has expired at block 809, the transmission procedure is ended and an indication to the higher layer on the transmission status is signaled.

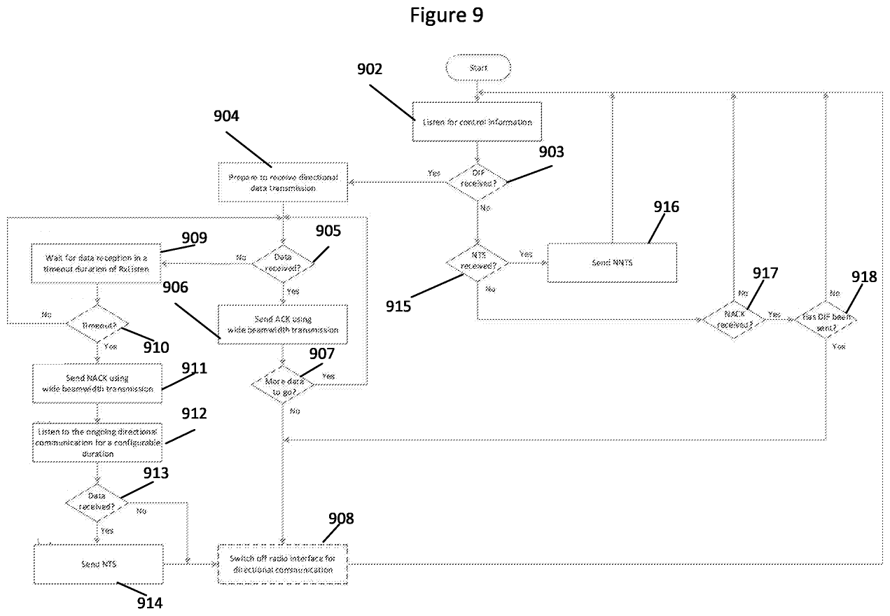

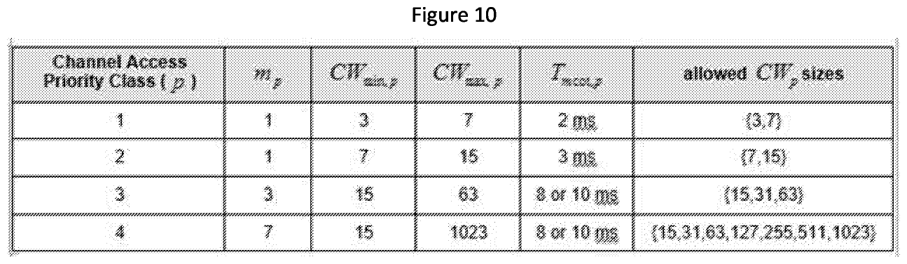

FIG. 9 illustrates a receiver side (e.g., wireless terminal UE1) flowchart for LAT using narrow and wide beam widths for control and data transmissions, respectively, where the data transmission from AN1 is carried out using directional communication. The receiver UE1 may also use receiver side beamforming to exploit the directivity gains for data reception. The control frames are transmitted using wide beam width, wireless terminal UE1 may use a wide beam width radiation pattern at the receiver side for reception of the control frames. The transceiver chain involved in directional data communication may be switched off or put in a power down mode to save energy when no exchange of data using directional communication is taking place.

At block 902, wireless terminal UE1 keeps listening for control frames transmitted using wide beam width.

At block 903, the wireless terminal keeps checking if it has received a DIF. If so, it switches its directional data communication receiver chain to switch to active mode at block 904 to be able to receive data frames from the source indicated in the DIF. This operation may involve necessary beamforming and beam tuning logic. In the flowchart of FIG. 9, the case when a node is not the intended receiver has not been shown. In this case when the DIF fields indicate that a node is not involved in the data communication, it would go to block 902.

At block 905, wireless terminal UE1 checks if a data frame is received over the directional link. If data is received, a corresponding ACK frame is sent out at block 906. At block 907, a receiving node checks if there are more data frames to follow. This information can be read from the data frame itself and/or the DIF received earlier. If there are no more data frames to be received, the receiver may optionally decide to switch off the radio hardware for directional communication to a low power mode to save energy consumption at block 908. At block 905, if a node is not able to receive data correctly sent out using the directional communication, the node waits for the timeout duration of RxListen at block 909 for the reception of a data frame.

At block 910, the node checks if the RxListen has timed out. If the timeout has not occurred yet, the node keeps waiting for the successful reception of the data frame, i.e., returns to block 905. If the timeout has occurred at block 910, the node sends out a NACK frame using wide beam width transmission at block 911.

At block 912, the node keeps on listening for any other interfering directional data frame transmissions. If data is received at block 913, a node can determine how long the data transmission will last (this information is embedded in the self-contained data frame header in the LAT scheme). If a data frame is received, just after the transmission ends, the node sends out an NTS frame using wide beam width transmission at block 914. After sending the NTS frame in this case, the node may switch off its directional communication radio transceiver chain to save power consumption. If no data has been received at block 913 after waiting for a configurable interval of time (this interval can be configured by the network operator), the node may switch off its directional communication radio transceiver chain to save power consumption at block 908.

At block 903, if no DIF is received, the node checks if it has received an NTS frame at block 915. If NTS is received at block 915, the node relays it as NNTS as part of the LAT procedure at block 916. The transmission of NTS and NNTS frames may allow an interfering node to refrain from any further transmissions for the duration indicated in the NTS and NNTS frames. This would allow another node to carry out its transmission without directional interference.

At block 917, the node checks if a NACK frame has been received. In case a NACK frame has been received, the node checks at block 918, if a prior DIF has been sent, i.e., it identifies the case when the directional transmission at its receiver has been interfered by another transmission. If it is identified at block 918 that a prior DIF has been sent, the directional communication transceiver chain is switched off and another data transmission is carried out in future. In contrast, if a NACK frame is received and a DIF has not been sent out, the node is not involved in the given transmission.

According to some embodiments of inventive concepts, listen-after-talk operations may be designed for high and low frequency spectra to provide more efficient communication. According to some embodiments, control and coordination aspects may be split from data transmissions using directional communication. According to some embodiments, control and data transmissions may be provided using low and high frequency spectra, respectively. High data rates may be achieved and spatial multiplexing may be exploited in high frequency spectrum typically in the range of centimeter and millimeter waves, whereas the low frequency spectrum (e.g., sub 6 GHz) may be used for robust coordination and control. Such a split of control and data plane using the medium access protocol as described herein may allow exploiting respective advantages of the low and high frequency spectra. The method described circumvents the

Issues of blockage and/or deafness associated with directional communication in high frequency spectrum may be reduced, and the low frequency spectrum may be used for fast signaling and control, and to re-establish the directional communication link. According to some embodiments, use of licensed frequencies maybe supported, and use of shared spectrum with both license assisted and standalone operations may be supported. Embodiments herein may enhance performance of the LAT operations by providing robust control, reducing chances of interfering transmissions, and/or enabling fast recovery.

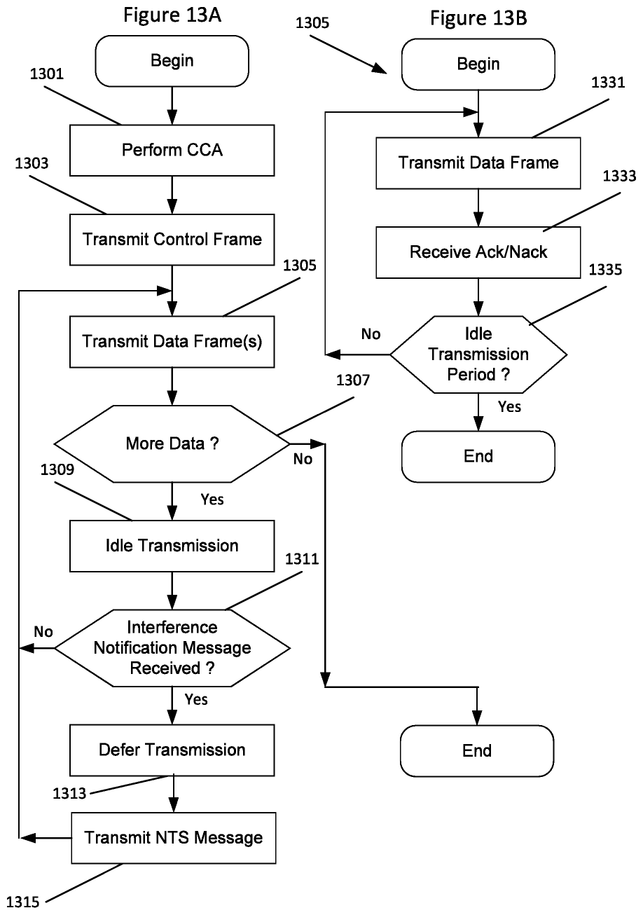

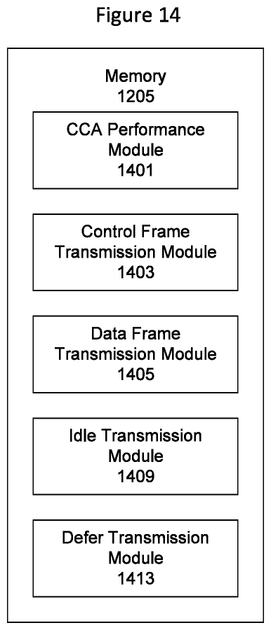

Operations of a network access node will now be discussed with reference to the flow chart of FIGS. 13A and 13B and the modules of FIG. 14. For example, modules of FIG. 14 may be stored in access node memory 1205 of FIG. 12, and these modules may provide instructions so that when the instructions of a module are executed by processor 1203, processor 1203 performs respective operations of the flow chart of FIGS. 13A-B.

At block 1301 of FIG. 13A, processor 1203 may perform a listen-before-talk (LBT) clear channel assessment (CCA) to determine that the data channel is not currently occupied (e.g., using CCA performance module 1401) before proceeding with listen-after-talk (LAT) operations according to some embodiments of inventive concepts. According to some other embodiments, processor 1203 may proceed with LAT operations without performing an LBT clear channel assessment.

At block 1303, processor 1203 may transmit a control frame (also referred to as a data indicator frame or DIF) through transceiver 1201 using a wide beam width transmission (e.g., using control frame transmission module 1403), and the control frame may include identification information for the access node AN1 and identification information for a receiving wireless terminal UE1. For example, the control frame may be transmitted from the access node using a half power beam pattern of at least 45 degrees or even using an omnidirectional beam pattern and/or using an antenna radiation pattern of no more than 5 dBi (so that the antenna gain is no more than 5 dBi higher in a particular direction compared to an isotropic antenna). Moreover, the control frame may be transmitted using at least one of a first (relatively low) set of frequencies consisting of frequencies less than 10 GHz (e.g., less than 6 GHz). The control frame may also include directional information for a the narrow beam width transmission used to transmit the data frame of block 1305. The receiving wireless terminal can then use this directional information to aid in the reception of the data frame (e.g., by tuning directional reception).

At block 1305, processor 1203 may transmit a data frame (corresponding to the control frame) including data for the receiving wireless terminal UE1 through transceiver 1201 using a narrow beam width transmission (e.g., using data frame transmission module 1405). For example, the data frame may be transmitted from the access node using a half power beam pattern of no more than 30 degrees and/or using an antenna radiation pattern of at least 10 dBi (so that the antenna gain is at least 10 dBi higher in a particular direction compared to an isotropic antenna). Moreover, the data frame may be transmitted using at least one of a second (relatively high) set of frequencies consisting of frequencies greater than 20 GHz (e.g., greater than 30 GHz). The control frame (including control plane information) may thus be transmitted using relatively low frequencies with relatively low directionality while the data frames (including user plane information) may be transmitting using relatively high frequencies with relatively high directionality.

As shown in FIG. 13B, transmitting a data frame at block 1305 may include transmitting a plurality of data frames including data for the wireless terminal UE1 using the narrow beam width transmission. The control frame, for example, may include information indicating a medium occupancy time over which data frames for the wireless terminal will be transmitted before an idle transmission period (used by the access node to listen for NTS messages from interfered wireless terminals). The control frame may be used to initiate transmission of groups of data frames where each group is followed by an idle transmission period and possibly a defer transmission period to allow another access terminal to share the resource. Each data frame of the first plurality of data frames may include a header and a data block. The header of each data frame of the first plurality of data frames may provide information regarding the idle period, and the data block of each data frame of the first plurality of data frames may include respective data for the receiving wireless terminal UE1.

For each data frame of a group of data frames transmitted over the medium occupancy time, processor 1203 may transmit the data frame at block 1331 and receive an Acknowledgment or Negative Acknowledgment (ACK or NACK) at block 1333 until the idle transmission period at block 1335. Responsive to an ACK from the wireless terminal at block 1333, processor 1203 may use the next data frame to transmit new data. Responsive to a NACK from wireless terminal at block 1333 processor 1203 may use a next data frame to retransmit data or processor 1203 may abort further transmission to the wireless terminal until receiving an NTS signal from the wireless terminal. Each data frame may thus be transmitted through transceiver 1201 using narrow beam transmission using at least one of the second set of relatively high frequencies as discussed above, but the ACK/NACK feedback may be received using at least one of the first set of relatively low frequencies as discussed above with respect to the control frame. Moreover, the ACK/NACK feedback may be received using wide beam directional reception or even omnidirectional beam reception.

At block 1307, processor 1203 may determine if there is more data to send to the wireless terminal before entering the idle transmission period. Provided that there is more data to send at block 1307, processor 1203 may idle transmission to the receiving wireless terminal UE1 for an idle listening period at block 1309 (e.g., using idle transmission module 1409). During the idle listening period, processor 1203 may listen for any interference notification messages (NTS messages) from any interfered wireless terminals (e.g., UE2) using at least one of the first set of relatively low frequencies and/or using wide beam reception. Responsive to receiving an interference notification message from an interfered wireless terminal UE2 using at least one of the first set of frequencies during the idle listening period at block 1311, processor 1203 may defer (1313) further transmission to the receiving wireless terminal (UE1) for a defer period at block 1313 (e.g., using defer transmission module 1413).

After the defer period, processor 1203 may transmit a notify-to-send (NTS) message to the interfered wireless terminal UE2 at block 1315 using the wide beam width transmission and using at least one of the first set of frequencies (e.g., using NTS transmission module 1415).

After transmitting the NTS message using the wide beam width transmission and using at least one of the first set of frequencies, processor may transmit a second plurality of data frames including data for the receiving wireless terminal UE1 at block 1305 (and blocks 1331, 1333, and 1335) using narrow beam width transmission and using at least one of the second set of frequencies (e.g., using data frame transmission module 1405).

Various operations of FIGS. 13A-B and/or modules of FIG. 14 may be optional with respect to some embodiments of network access nodes and related methods. For example, operations of blocks 1301, 1307, 1309, 1311, 1313, 1315, 1331, 1333, and 1335 of FIGS. 13A-B may be optional, and regarding related access nodes, modules 1401, 1409, and 1413 of FIG. 14 may be optional.

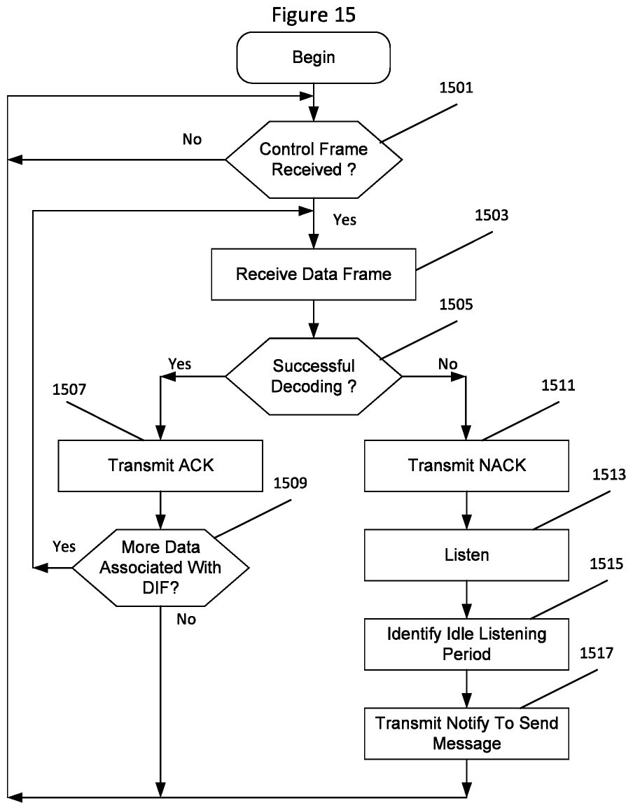

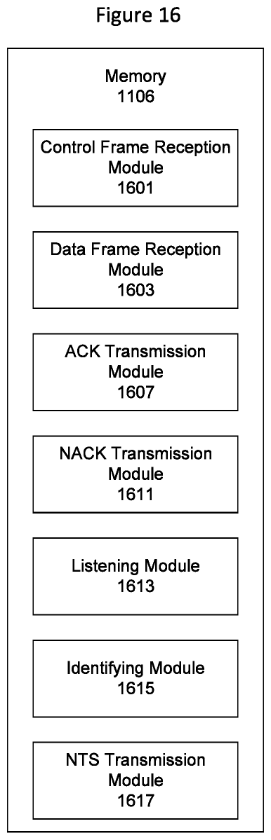

Operations of a wireless terminal will now be discussed with reference to the flow chart of FIG. 15 and the modules of FIG. 16. For example, modules of FIG. 16 may be stored in wireless terminal memory 1105 of FIG. 11, and these modules may provide instructions so that when the instructions of a module are executed by processor 1103, processor 1103 performs respective operations of the flow chart of FIG. 15.

Wireless terminal processor 1103 may receive a control frame (also referred to as a data frame indicator or DIF) including control plane information from the access node through transceiver 1101 using at least one of the first set of (relatively low) frequencies at block 1501 (e.g., using control frame reception module 1601), and the control frame may include identification information for the access node AN1 and identification information for the wireless terminal UE1. The frequencies of the first set of frequencies may be less than 10 GHz (e.g., less than 6 GHz). Receiving the control frame may include receiving the control frame using wide beam width reception using at least one of the first set of frequencies, for example, using a half power reception beam pattern of at least 45 degrees or even using an omnidirectional reception beam pattern and/or using an antenna radiation pattern of no more than 5 dBi (so that the antenna gain is no more than 5 dBi higher in a particular direction compared to an isotropic antenna).

At block 1503, processor 1103 may receive a data frame (including user plane information) through transceiver 1103 from the access node AN1 using at least one of the second set of (relatively high) frequencies (e.g., using data frame reception module 1603). The frequencies of the second set of frequencies may be greater than 20 MHz (e.g., greater than 30 MHz). The data frame includes data for the wireless terminal UE1, and the data frame corresponds to the control frame. Receiving the data frame comprises receiving the data frame using narrow beam width reception using at least one of the second set of frequencies, for example, using a half power reception beam pattern of no more than 30 degrees and/or using an antenna radiation pattern of at least 10 dBi (so that the antenna gain is at least 10 dBi higher in a particular direction compared to an isotropic antenna). In addition, the control frame may include directional information for a narrow beam width transmission used by the access node to transmit the data frame of block 1503. Processor 1103 tune the narrow beam width reception used to receive the data frame using the directional information.

As discussed above, the control frame may also include information indicating a medium occupancy time defining a duration for communication of a plurality of data frames including data for the wireless terminal UE1 before an idle listening period and/or a defer period, and each of the plurality of data frames corresponds to the control frame. The duration defined by the medium occupancy time may be configured by the network operation (e.g., at the access node and/or base station). The duration defined by the medium occupancy time, for example, may be adjusted based on interference level encountered, fairness to nodes, queued packet times (latency) at nodes, etc. Accordingly, operations of blocks 1503, 1505, 1507, and 1509 may be repeated to receive a plurality of data frames including data for the wireless terminal UE1 using at least one of the second set of frequencies. According to some embodiments, processor 1103 may receive a group of data frames from the access node before the access node enters an idle listening period and/or a defer period as discussed above with respect to the access node. Accordingly, delays may be introduced between reception of groups of data frames associated with the control frame.

For each data frame received at wireless terminal UE1, processor 1103 may either transmit an Acknowledgment (ACK) through transceiver 1101 at block 1507 responsive to successful decoding at block 1505 (e.g., using ACK transmission module 1607), or processor 1103 may transmit a Negative Acknowledgment NACK through transceiver 1101 at block 1511 responsive to unsuccessful decoding at block 1505 (e.g., using NACK transmission module 1611). More particularly, each ACK and/or NACK may be transmitted using at least one of the first set of frequencies and/or using wide band transmission.

Responsive to failure to decode/receive a data frame at block 1505, processor 1103 may thus transmit a negative acknowledgment message using at least one of the first set of frequencies at block 1511 (e.g., using NACK transmission module 1611). Responsive to failure to decode/receive a data frame, processor may also listen for an interfering data frame using at least one of the second set of frequencies at block 1513 (e.g., using listening module 1613). Responsive to receiving a header of an interfering data frame using at least one of the second set of frequencies, processor 1103 may identify an idle listening period based on the header of the interfering data frame at block 1515 (e.g., using identifying module 1615), and transmitter may transmit a notify to send message (also referred to as an interference notification message) using at least one of the first set of frequencies during the idle listening period at block 1517 (e.g., using NTS transmission module 1617).

After transmitting the notify to send message, processor 1103 may receive a new control frame using at least one of the first set of frequencies at block 1501 (e.g., using control frame reception module 1601), and the new control frame may include identification information for the wireless terminal. At block 1503, processor 1103 may receive a new data frame(s) corresponding to the new control frame, and the new data frame may be received using at least one of the second set of frequencies. Responsive to receiving the third data frame corresponding to the third control frame, processor 1103 may transmitting an acknowledgment through transceiver 1101 using at least one of the first set of frequencies at block 1507 (e.g., using ACK transmission module 1607).

Various operations of FIG. 15 and/or modules of FIG. 16 may be optional with respect to some embodiments of wireless terminals and related methods. For example, operations of blocks 1505, 1507, 1509, 1511, 1513, 1515, and 1517 of FIG. 15 may be optional, and regarding related wireless terminals, modules 1607, 1611, 1613, 1615, and 1617 of FIG. 16 may be optional.

As discussed above, operations of FIGS. 13A, 13B, and 15 may be applied for downlink communications from an access node to a wireless terminal. According to some other embodiments of inventive concepts, operations of FIGS. 13A, 13B, and 15 may be applied for uplink communications from a wireless terminal to an access node, or for sidelink communications (also referred to as device-2-device or D2D communications) from one wireless terminal to another. For uplink communications, a wireless terminal may perform operations of FIGS. 13A and 13B, and an access node may perform operations of FIG. 15. For sidelink communications, a first wireless terminal may perform operations of FIGS. 13A and 13B, and a second wireless terminal may perform operations of FIG. 15. Moreover, while one to one communications are discussed by way of example, embodiments of inventive concepts may be applied to one to many communications, such as multicast and/or multiuser communications.

### Abbreviations

| Abbreviation | Explanation |
|---|---|
| ACK | Acknowledgement |
| AN | Access Network |
| AP | Access Point |
| ARQ | Automated Repeat request |
| BO | Backoff |
| BS | Base station |
| CCA | Clear Channel Assessment |
| CFP | Contention Free Period |
| CW | Contention Window |
| DCF | Distributed Coordination Function |
| DIF | Data Indication Frame |
| DIFS | DCF Inter-frame Spacing |
| DL | Downlink |
| DRS | Discovery Reference Signal |
| eNB | evolved NodeB, base station |
| LAT | Listen After Talk |
| LBT | Listen Before Talk |
| MCS | Modulation Coding Scheme |
| MU-MIMO | Multi user multiple input multiple output |
| NR | New Radio (refers to the 5G radio interface) |
| NNTS | Notify not to send |
| NTS | Notify to send |
| QoS | Quality of Service |
| RB | Resource Block |
| RF | Radio Frequency |
| SCell | Secondary Cell |
| SIFS | Short Inter-frame Spacing |
| STA | Station |
| UE | User Equipment |
| UL | Uplink |

### Further Definitions and Embodiments

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit (e.g., a Central Processing Unit CPU, Graphics Processing Unit GPU, Digital Signal Processor DSP, Field Programmable Gate Array FPGA, Application Specific Integrated Circuit ASIC, etc.) of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

1. A method of operating a first wireless communication node (AN1), comprising:
transmitting a control frame using a wide beam width transmission, wherein the control frame includes identification information for the first wireless communication node (AN1) and identification information for a second wireless communication node (UE1); and
transmitting a data frame including data for the second wireless communication node (UE1) using a narrow beam width transmission, wherein the data frame corresponds to the control frame.

2. The method of claim 1, wherein transmitting the control frame comprises transmitting the control frame using the wide beam width transmission using at least one of a first set of frequencies, wherein transmitting the data frame comprises transmitting the data frame using the narrow beam width transmission using at least one of a second set of frequencies, and wherein frequencies of the first set of frequencies are lower than frequencies of the second set of frequencies.

3. The method of claim 2, wherein the frequencies of the first set of frequencies are less than 10 GHz, and wherein the frequencies of the second set of frequencies are greater than 20 GHz.

4. The method of claim 2, wherein transmitting the data frame comprises transmitting a plurality of data frames including data for the second wireless communication node (UE1) using the narrow beam width transmission.

5. The method of claim 4, wherein the control frame also includes information indicating a medium occupancy time for transmission of the plurality of data frames including the data for the second wireless communication node (UE1), and wherein each of the plurality of data frames corresponds to the control frame.

6-15. (canceled)

16. A method of operating a first wireless communication node (UE1) in communication with a second wireless communication node (AN1), comprising:
receiving a control frame from the second wireless communication node using at least one of a first set of frequencies, wherein the control frame includes identification information for the second wireless communication node (AN1) and identification information for the first wireless communication node (UE1); and
receiving a data frame from the second wireless communication node (AN1) using at least one of a second set of frequencies, wherein the data frame includes data for the first wireless communication node (UE1), wherein the data frame corresponds to the control frame, and wherein frequencies of the first set of frequencies are lower than frequencies of the second set of frequencies.

17. The method of claim 16, wherein receiving the control frame comprises receiving the control frame using wide beam width reception using at least one of the first set of frequencies, and wherein receiving the data frame comprises receiving the data frame using narrow beam width reception using at least one of the second set of frequencies.

18. The method of claim 16, wherein the frequencies of the first set of frequencies are less than 10 GHz, and wherein the frequencies of the second set of frequencies are greater than 20 GHz.

19. The method of claim 14, wherein receiving the data frame comprises receiving a plurality of data frames including data for the first wireless communication node (UE1) using at least one of the second set of frequencies.

20. The method of claim 19, wherein the control frame also includes information indicating a medium occupancy time for communication of the plurality of data frames including the data for the first wireless communication node (UE1), and wherein each of the plurality of data frames corresponds to the control frame.

21-30. (canceled)

31. A first wireless communication node (AN1), comprising:
a transceiver configured to provide wireless communications; and
a processor coupled with the transceiver, wherein the processor is configured to provide wireless communication through the transceiver, and wherein the processor is configured to,
transmit a control frame using a wide beam width transmission, wherein the control frame includes identification information for the first wireless communication node (AN1) and identification information for a second wireless communication node (UE1), and
transmit a data frame including data for the second wireless communication node (UE1) using a narrow beam width transmission, wherein the data frame corresponds to the control frame.

32. The first wireless communication node of claim 31, wherein transmitting the control frame comprises transmitting the control frame using the wide beam width transmission using at least one of a first set of frequencies, wherein transmitting the data frame comprises transmitting the data frame using the narrow beam width transmission using at least one of a second set of frequencies, and wherein frequencies of the first set of frequencies are lower than frequencies of the second set of frequencies.

33. The first wireless communication node of claim 32, wherein the frequencies of the first set of frequencies are less than 10 GHz, and wherein the frequencies of the second set of frequencies are greater than 20 GHz.

34. The first wireless communication node of claim 31, wherein transmitting the data frame comprises transmitting a plurality of data frames including data for the second wireless communication node (UE1) using the narrow beam width transmission.

35. The first wireless communication node of claim 34, wherein the plurality of data frames is a first plurality of data frames, and wherein the processor is further configured to,
idle transmission to the second wireless communication node (UE1) for an idle listening period after transmitting the first plurality of data frames including the data for the second wireless communication node (UE1),
defer further transmission to the second wireless communication node (UE1) for a defer period responsive to receiving an interference notification message from an interfered wireless terminal (UE2) using at least one of the first set of frequencies during the idle listening period,
transmit a notify-to-send (NTS) message to the interfered wireless terminal (UE2) using the wide beam width transmission and using at least one of the first set of frequencies after the defer period, and
transmit a second plurality of data frames including data for the second wireless communication node (UE1) using the narrow beam width transmission and using at least one of the second set of frequencies after transmitting the NTS message using the wide beam width transmission and using at least one of the first set of frequencies.

36. A first wireless communication node (UE1), comprising:
a transceiver configured to provide wireless communications; and
a processor coupled with the transceiver, wherein the processor is configured to provide wireless communication through the transceiver, and wherein the processor is configured to,
receive a control frame from a second wireless communication node using a first set of frequencies, wherein the control frame includes identification information for the second wireless communication node (AN1) and identification information for the first wireless communication node (UE1), and
receive a data frame from the second wireless communication node (AN1) using a second set of frequencies, wherein the data frame includes data for the first wireless communication node (UE1), wherein the data frame corresponds to the control frame, and wherein frequencies of the first set of frequencies are lower than frequencies of the second set of frequencies.

37. The first wireless communication node of claim 36, wherein receiving the control frame comprises receiving the control frame using wide beam width reception using the first set of frequencies, and wherein receiving the data frame comprises receiving the data frame using narrow beam width reception using the second set of frequencies.

38. The first wireless communication node of claim 36, wherein the frequencies of the first set of frequencies are less than 10 GHz, and wherein the frequencies of the second set of frequencies are greater than 20 GHz.

39. The first wireless communication node of claim 36, wherein the data frame indicator is a first data frame indicator, wherein the data frame is a first data frame, and wherein the processor is further configured to,
receive a second control frame using the first set of frequencies, wherein the second control frame includes identification information for the first wireless communication node;
transmit a negative acknowledgment message using the first set of frequencies responsive to failure to receive and/or decode a second data frame corresponding to the second control frame,
listen for an interfering data frame using the second set of frequencies responsive to failure to receive a data frame corresponding to the second control frame,
identify an idle listening period based on the header of the interfering data frame responsive to receiving a header of an interfering data frame using the second set of frequencies,
transmit a notify to send message using the first set of frequencies during the idle listening period,
receive a third control frame using the first set of frequencies after transmitting the notify to send message, wherein the third control frame includes identification information for the first wireless communication node;
receive a third data frame corresponding to the third control frame, wherein the third data frame is received using the second set of frequencies, and
transmit an acknowledgment using the first set of frequencies responsive to receiving the third data frame corresponding to the third control frame.
